(19) United States
(12) Patent Application Publication
(10) Pub. No.: US 2014/0289719 A1
(43) Pub. Date: Sep. 25, 2014

(54) AUTOMATIC VERSION MANAGEMENT

(71) Applicant: Google Inc., Mountain View, CA (US)

(72) Inventor: Rajat Dewan, Mountain View, CA (US)

(73) Assignee: Google Inc., Mountain View, CA (US)

(21) Appl. No.: 13/847,623

(22) Filed: Mar. 20, 2013

(51) Int. Cl. G06F 9/44

(52) U.S. Cl. CPC G06F 8/71
USPC 717/170

(57) ABSTRACT

Methods and systems for automatically providing a second version of an application may include receiving performance criteria for an application and determining a performance issue relating to a first version of the application. A second version of the application may be automatically provided, and the second version may be a last known working version of the application. Additionally, performance criteria for an application may be received and a performance issue relating to a first version of the application may be determined. The performance issue may be specific to a demographic. A second version of the application may be provided, and the second version may correct the performance issue for the demographic. The performance criteria may be received from one or more devices, and the second version of the application may be identified based on the performance criteria received from the devices.

### BACKGROUND

Software applications typically need periodic updates. These updates may be for new product features, security enhancement, performance, or other improvements. In general, application providers allow for automatic and/or on demand updates of an application on a device. However, as the application industry expands, so do the issues relating to maintenance of application performance and management of application versions. For example, a version of an application may encounter performance issues for a specific demographic or a version of an application may have performance issues on all devices, resulting in user dissatisfaction and impaired application operability.

### BRIEF SUMMARY

According to an implementation of the disclosed subject matter, performance criteria may be received for an application. At least one performance issue relating to a first version of the application may be determined. Next, a second version of the application may be automatically provided, and the second version may be a last known working version of the application.

According to an implementation of the disclosed subject matter, performance criteria for an application may be received. At least one performance issue relating to a first version of the application may be determined, which may be specific to a demographic. Next, a second version of the application may be provided, and the second version may correct the performance issue for the application and/or the demographic.

An implementation of the disclosed subject matter provides a system that includes a processor configured to receive performance criteria for an application. The system may determine at least one performance issue relating to a first version of the application. Next, a second version of the application may be automatically provided, which may be a last known working version of the application.

An implementation of the disclosed subject matter provides a system that includes a processor configured to receive performance criteria for an application. The system may determine at least one performance issue relating to a first version of the application, and the at least one performance issue may be specific to a demographic. Next, the system may automatically provide a second version of the application, and the second version may correct the at least one performance issue for the demographic.

According to an implementation of the disclosed subject matter, a computer readable medium storing a plurality of instructions that cause a processor to receive performance criteria for an application is provided. At least one performance issue relating to a first version of the application may be determined. Next, a second version of the application may be automatically provided, and the second version may be a last known working version of the application.

Additionally, an implementation of the disclosed subject matter provides a computer readable medium storing a plurality of instructions that cause a processor to receive performance criteria for an application is provided. The processor may determine at least one performance issue relating to a first version of the application, and the at least one performance issue may be specific to a demographic. Next, the processor may automatically provide a second version of the application, and the second version may correct the at least one performance issue for the demographic.

Implementations of the disclosed subject matter may provide improved monitoring of an application's performance and easier management of application versions across the market. The disclosed subject matter provides devices with an automatic application update that corrects a performance issue that the application has been experiencing, which may result in improved application operability and increased user satisfaction. Additional features, advantages, and implementations of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows an example process according to an implementation of the disclosed subject matter.

FIG. 3 shows an example information flow according to an implementation of the disclosed subject matter.

FIG. 4 shows an example information flow according to an implementation of the disclosed subject matter.

FIG. 5 shows a computer according to an implementation of the disclosed subject matter.

FIG. 6 shows a network configuration according to an implementation of the disclosed subject matter.

### DETAILED DESCRIPTION

In general, given the expanding application market, it can be challenging to monitor an application's performance across devices and manage versions of an application based on performance criteria. Thus, it may be advantageous to identify performance issues that a version of an application is experiencing, and/or performance issues specific to a demographic, and automatically stop providing that version of the application to all devices, or to the specific demographic as disclosed herein. In the case where a version of an application is having performance issues on all devices, it may be beneficial to provide a different version of the application, e.g., the last known working version of the application or a new version of the application, to all devices. In the case where a version of an application is having performance issues relating to a specific demographic, it may be beneficial to provide a different version of the application, e.g., the last known working version of the application or a new version of the application, to the specific demographic that has been experiencing the performance issue.

As an example, a user may have previously downloaded a weather application version 2.3 on his Smartphone 4 brand mobile phone. A system may receive performance reports relating to the weather application 2.3. In particular, the system may identify performance issues that the weather application 2.3 is having on Smartphone 4 devices. As a result, the system may automatically replace the weather application 2.3 by installing the last known working version (e.g., version 2.2) of the weather application on the user's device, or on all Smartphone 4 devices or all similar devices, such as all Smartphone 4 devices having a configuration similar or identical to the user's.

As another example, a user may have previously downloaded a stock ticker application version 5.0 on his mobile device. A system may receive performance reports relating to the stock ticker application 5.0. Specifically, the system may determine that there have been errors/issues with the stock ticker application 5.0 on all mobile devices. Accordingly, the system may automatically replace the stock ticker application version 5.0 by providing the most recent working version of the stock ticker application (e.g., version 4.0). Alternatively, the system may automatically notify the user that the stock ticker application 5.0 has performance issues and suggest that the user manually install the most recent working version of the stock ticker application (e.g., version 4.0).

For example, a mobile operating system may receive performance criteria for an application such as crash reports, activity not responding reports, battery reports, running services reports, user initiated feedback reports, network reports, and the like. The mobile operating system may provide these performance criteria to an application provider. A system may evaluate and monitor this performance information to determine if there have been any changes in the performance of the application on all devices or specific to a particular demographic. If there has been an increase in performance issues relating to a specific version of the application or relating to a particular demographic, the application provider may stop providing the specific version of the application. Additionally, the system may automatically provide the last known working version of the application or automatically provide a different version, thereby correcting the performance issue.

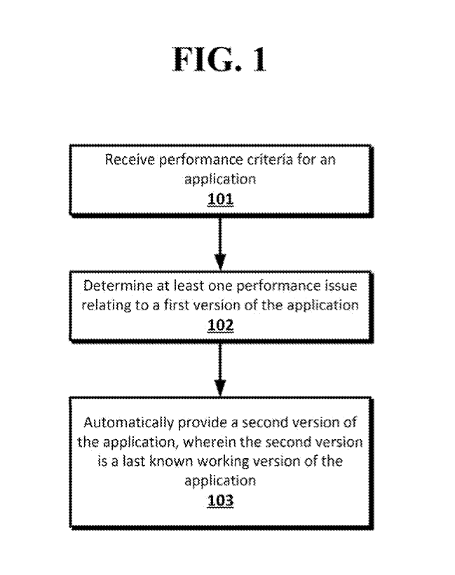

More generally, an implementation of the disclosed subject matter provides a method for automatically providing an application, as shown in FIG. 1. The method may include receiving performance criteria for an application, at 101. As shown at 102, at least one performance issue relating to a first version of the application may be determined as previously described. Next, a second version of the application may be automatically provided, at 103, as previously described. The second version may be a last known working version of the application, a new version of the application, a previously-installed version of the application, or the like. In an implementation, the second version of the application may be installed.

An implementation of the disclosed subject matter provides a system that includes a processor configured to receive performance criteria for an application. The system may determine at least one performance issue relating to a first version of the application. Next, a second version of the application may be automatically provided, and the second version may be a last known working version of the application.

According to an implementation of the disclosed subject matter, a computer readable medium storing a plurality of instructions that cause a processor to receive performance criteria for an application is provided. At least one performance issue relating to a first version of the application may be determined. Next, a second version of the application may be automatically provided, and the second version may be a last known working version of the application.

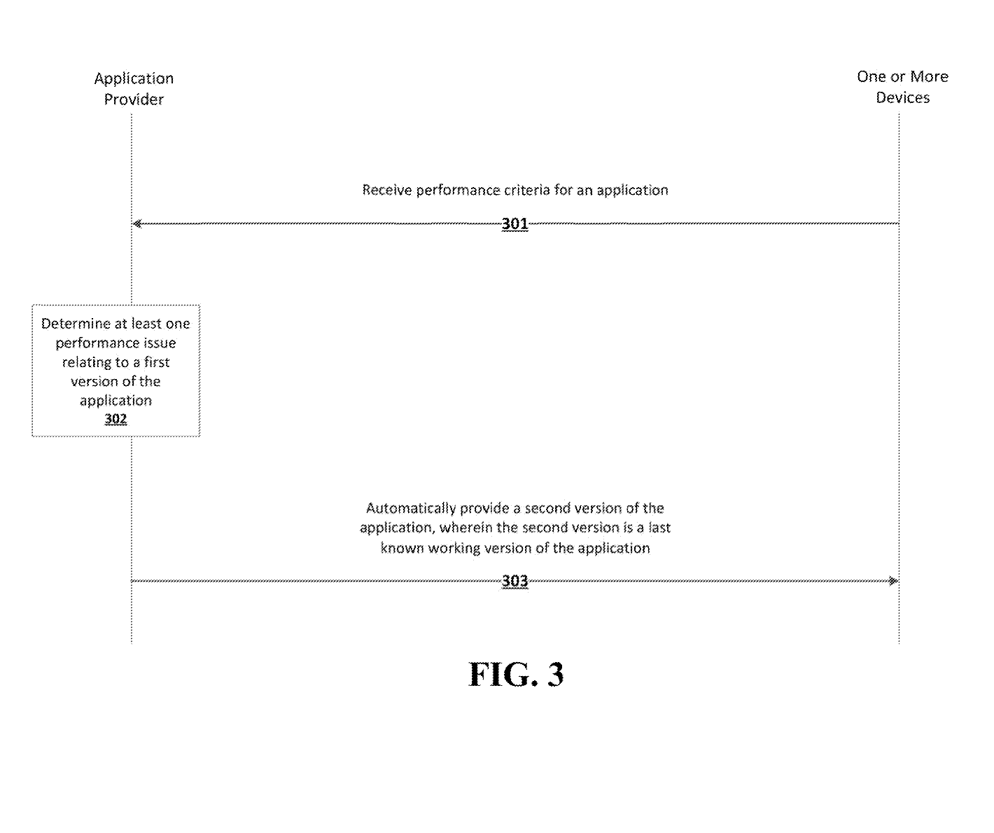

For example, as shown in FIG. 3, an application provider receives performance criteria for an application from one or more devices. The application provider may determine at least one performance issue relating to a first version of the application. Next, the application provider may automatically provide a second version of the application to the one or more devices, such as a last known working version a new version of the application, a previously-installed version of the application, or the like.

An application provider may be an application store, an application marketplace, an application developer, an application database, an application library, and any other provider of applications.

Additionally, according to an implementation of the disclosed subject matter, the performance criteria discussed above may be received from one or more devices. Accordingly, the second version of the application may be identified based on the performance criteria received from the one or more devices. A device may be, for example, a mobile device, a smartphone, a laptop, a tablet, a PC, a wearable computer, an appliance, and any other device capable of running an application. For example, performance criteria may be received from mobile devices, smartphones, laptops, and tablets, all of which may have version 2.0 of an application. Based on the performance criteria received, an application provider may determine a performance issue with version 2.0 of the application. Accordingly, the application provider may automatically provide the last known working version of the application, such as version 1.0, to the mobile devices, smartphones, laptops, and tablets. Additionally, the application provider may provide the last known working version of the application, such as version 1.0, to all devices (including devices from which performance criteria was not received) with version 2.0 of the application.

As discussed above, performance criteria may include application crash reports, activity not responding reports, performance testing reports, battery reports, running services reports, user initiated feedback reports, network reports, and any other criteria indicating the performance of an application. More generally, performance criteria may include any information or data that describes the performance of an application on a computer platform.

The performance criteria may be used to determine a performance issue which may include a run time error, an application failure, an activity not responding error, a user-initiated negative feedback, a poor battery usage report, a processing delay, a processing error, a trapped error, a network error, and any other issue relating to the performance of the first version of the application. In an implementation, a performance issue may indicate that the application failed to meet the performance criteria for the application. More generally, performance issues as disclosed herein may include any data, information, or events that indicate a performance of an application that does not meet the intended operating parameters for the application.

As an example, an application provider may receive performance criteria for a city guide application version 3.2 from multiple device models or types such as Smartphone 4, Smartphone 2, tablets, and laptops. The performance criteria may include user-initiated negative feedback reports (e.g., received from users of the city guide application version 3.2). Additionally, the performance criteria may include application crash reports from multiple Smartphone 4 devices, performance-testing reports from multiple Smartphone 2 devices, network reports from multiple tablets, and running services reports from multiple laptops. Based on the application crash reports, performance testing reports, network reports, and running services reports, the application provider may determine that the city guide application version 3.2 has performance issues. Specifically, the application provider may determine that application version 3.2 is experiencing application failure on Smartphone 4 devices, poor battery usage on Smartphone 2 devices, network errors on tablets, and processing errors on laptops. Accordingly, the application provider may automatically provide version 2.8 of the city guide application (the last known working version of city guide application) to Smartphone 4, Smartphone 2, tablet, and laptop devices. Alternatively, the application provider may automatically provide version 2.8 to Smartphone 4 and Smartphone 2 devices and version 2.4 to tablet and laptop devices, where version 2.8 is the last known working version of the application on Smartphone 4 devices and version 2.4 is the last known working version of the application on tablet and laptop devices. Similarly, the application provider may automatically provide a version newer than version 2.9 to some or all of the types of applications that are identified as having one or more performance issues.

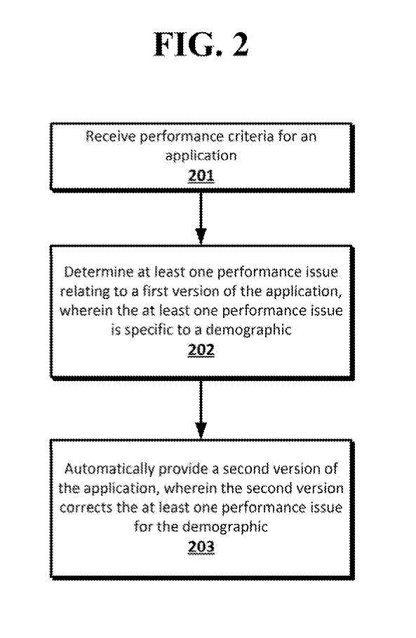

Turning to FIG. 2, an implementation of the disclosed subject matter provides a method for automatically providing an application. The method may include receiving performance criteria for an application, at 201, as disclosed herein. At least one performance issue relating to a first version of the application may be determined at 202, and the at least one performance issue may be specific to a demographic. Next, a second version of the application may be provided at 203, and the second version may correct the at least one performance issue for the demographic as disclosed herein.

An implementation of the disclosed subject matter provides a system that includes a processor configured to receive performance criteria for an application. The system may determine at least one performance issue relating to a first version of the application, and the at least one performance issue may be specific to a demographic. Next, the system may automatically provide a second version of the application, and the second version may correct the at least one performance issue for the demographic.

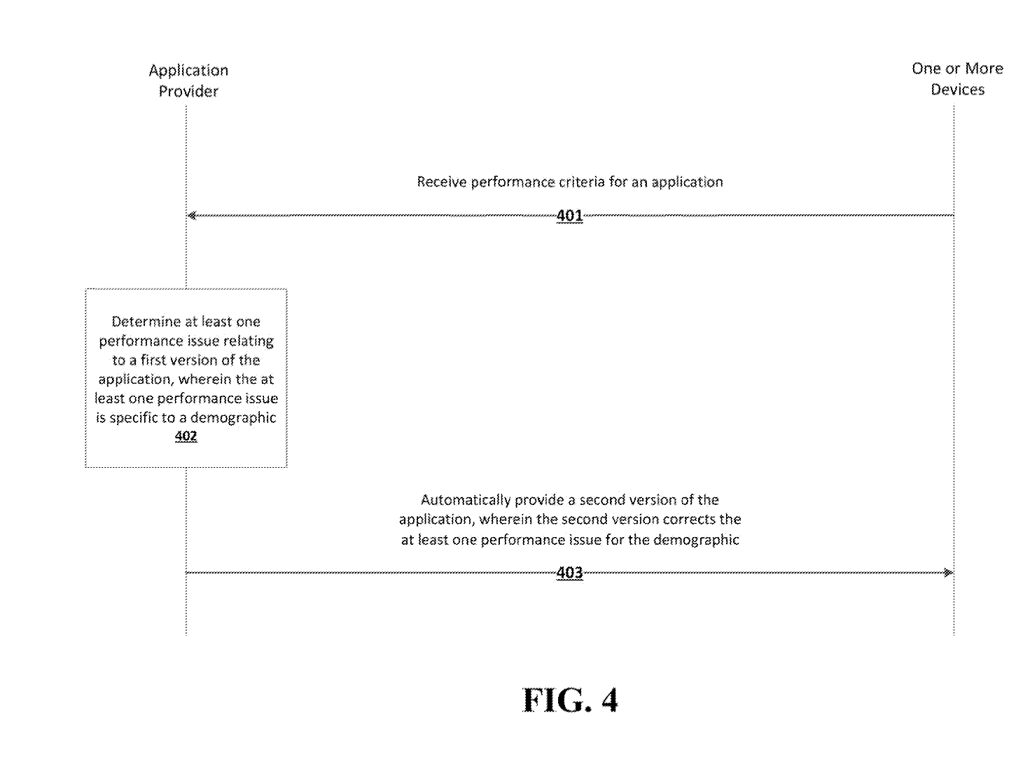

As an example, FIG. 4 shows that an application provider may receive performance criteria for an application from one or more devices. Next, the application provider may determine at least one performance issue relating to a first version of the application. The performance issue may be specific to a demographic. Accordingly, the application provider may automatically provide a second version of the application to the one or more devices. The second version may correct the at least one performance issue for the demographic.

Additionally, an implementation of the disclosed subject matter provides a computer readable medium storing a plurality of instructions that cause a processor to receive performance criteria for an application is provided. The processor may determine at least one performance issue relating to a first version of the application, and the at least one performance issue may be specific to a demographic. Next, the processor may automatically provide a second version of the application, and the second version may correct the at least one performance issue for the demographic.

A demographic may refer to any segment of the population running an application and may refer to a device, a device manufacturer, OS version, locale, carrier, cellular standard, geographic region, and any other demographic having the at least one performance issue. For example, a demographic may be based on the particular device running an application such as Smartphone 4 devices, a specific brand of devices, the OS version on the device and/or any other device characteristic that may affect application performance. As another example, a demographic may be based on a specific wireless carrier of a device and/or a cellular standard offered by a wireless carrier, such as, CDMA, GSM, 3G, 4G, 4G LTE, and the like. A demographic may also be based on the locale and/or geographic region associated with a device and/or user. For example, a locale or geographic region may refer to a zip code, area code, city, county, state, country, continent, and/or a region of the world. Further, a demographic may include any combination of the above-described characteristics of a device, a carrier, and location and may further include any other characteristics that may affect application performance.

As used herein, a second version may be a last known working version of the application, a new version of the application, a beta version of the application, a test version of the application, an unstable version of the application, or a previous version of the application. For example, there may be several versions of a recipe application available in an application store and/or on the market. Version 8 may be the newest version of the recipe application available in North America and version 7 may be the last known working version in North America. For the same recipe application, version 6 may be the newest version available in Europe and version 4 may be the last known working version in Europe. Further, version 3 may be an unstable version and version 9T may be a test version available for all tablet devices.

As an example, performance criteria may be received from all devices running version 6 of a social network application. The performance criteria may include activity not responding reports, user-initiated feedback reports, and performance testing reports from all devices. Based on the reports, it may be determined that version 6 of the social network application is experiencing activity not responding errors on all GSM devices in North America and poor performance test results on tablets in Japan. Accordingly, a new version 7 of the social network application may be provided to all GSM devices in North America and a test version 6 T of the social network application may be provided to all tablet devices in Japan.

The second version of the application may correct a performance issue for a given demographic. Further, a second version may correct a performance issue by eliminating or reducing the effect of a performance issue. For example, a battery report may be received for version 3 of an application and it may be determined that version 3 is experiencing poor battery usage. Accordingly, the application provider may automatically provide version 2 of the application, where version 2 has better battery usage than version 3. As another example, crash reports may be received from multiple devices for version Q of an application. Based on the crash reports, the application provider may determine that version Q is experiencing a high number of application failures. As a result, the application provider may automatically provide a new version S that is expected to eliminate the application failure issue of version Q.

As another example, an application provider may receive performance criteria for version 4.0 of an airline application from all devices running version 4.0 of the airline application. In particular, the performance criteria may include user initiated feedback reports and network reports from Smartphone 3 devices on a 3G wireless network. An application provider may determine that the user initiated feedback reports indicate user-initiated negative feedback and network errors for the specific demographic of Smartphone 3 devices on a 3G wireless network running version 4.0. The application provider may automatically provide a beta version 4.1 of the airline application to the demographic of all Smartphone 3 devices on a 3G wireless network. Beta version 4.1 may correct the issue addressed in the user-initiated negative feedback reports and eliminate the network errors that were determined for version 4.0.

In an implementation, the communication between devices and an application provider may be across one or more bridges between the interfaces. For example, the communications between the devices and the application provider may be managed or assisted by a third device, such as, a coordinating device, a local coordinator, a remote server, etc. In such cases, the third device may, for example, receive performance criteria from the devices and determine a performance issue relating to a first version of an application. The third device may then provide the performance issue to the application provider, in which case, the application provider may provide a second version of the application to the devices. Alternatively, the third device may receive performance criteria from the devices and provide the performance criteria to the application provider. The application provider may determine a performance issue based on the performance criteria relating to the first version of the application. Accordingly, the application provider may provide a second version of the application to the devices. In an embodiment, the third device may also act as a bridge between the application provider and the devices when providing the second version of the application to the devices. Furthermore, more than one intermediate device may be implemented to facilitate communication between devices and an application provider.

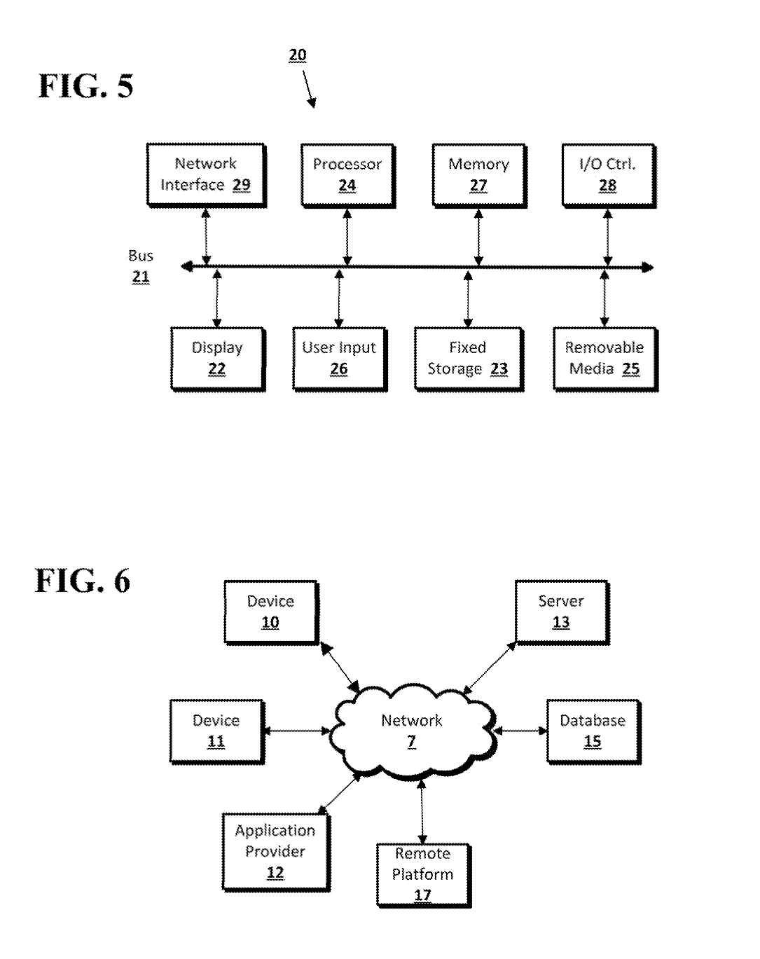

Implementations of the presently disclosed subject matter may be implemented in and used with a variety of component and network architectures. FIG. 5 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 6.

Many other devices or components (not shown) may be connected in a similar manner (e.g., document scanners, digital cameras and so on). Conversely, all of the components shown in FIG. 5 need not be present to practice the present disclosure. The components can be interconnected in different ways from that shown. The operation of a computer such as that shown in FIG. 5 is readily known in the art and is not discussed in detail in this application. Code to implement the present disclosure can be stored in computer-readable storage media such as one or more of the memory 27, fixed storage 23, removable media 25, or on a remote storage location.

FIG. 6 shows an example network arrangement according to an implementation of the disclosed subject matter. One or more clients 10, 11, such as local computers, smart phones, tablet computing devices, and the like may connect to other devices and/or the application provider 12 via one or more networks 7. The network may be a local network, wide-area network, the Internet, or any other suitable communication network or networks, and may be implemented on any suitable platform including wired and/or wireless networks. The clients may communicate with one or more servers 13, application providers 12, and/or databases 15. The devices and/or application providers 12 may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the systems discussed here collect personal information about users, or may make use of personal information, the users may be provided with an opportunity to control whether programs or features collect user information (e.g., information about a user's application performance, device characteristics, locale or region, device carrier, user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving performance criteria for an application;
determining at least one performance issue relating to a first version of the application, and
automatically providing a second version of the application, wherein the second version is a last known working version of the application.

2. The method of claim 1, wherein the performance criteria are received from one or more devices, further comprising identifying the second version of the application based on the performance criteria received from the one or more devices.

3. The method of claim 2, wherein the one or more devices includes at least one selected from the group consisting of a mobile device, smartphone, laptop, tablet, PC, wearable computer, appliance, and any other device capable of running an application.

4. The method of claim 1, wherein the performance criteria is at least one selected from the group consisting of application crash reports, activity not responding reports, performance testing reports, battery reports, running services reports, user initiated feedback reports, network reports, and any other criteria indicating the performance of an application.

5. The method of claim 1, wherein the at least one performance issue is selected from the group consisting of a run time error, an application failure, an activity not responding error, a user-initiated negative feedback, a poor battery usage report, a processing delay, a processing error, a trapped error, a network error, and any other issue relating to the performance of the first version of the application.

6. The method of claim 1, wherein the at least one performance issue indicates that the application failed to meet the performance criteria for the application.

7. A method comprising:
receiving performance criteria for an application;
determining at least one performance issue relating to a first version of the application, wherein the at least one performance issue is specific to a demographic, and
automatically providing a second version of the application, wherein the second version corrects the at least one performance issue for the demographic.

8. The method of claim 7, wherein the performance criteria are received from one or more devices, further comprising identifying the second version of the application based on the performance criteria received from the one or more devices.

9. The method of claim 8, wherein the one or more devices includes at least one selected from the group consisting of a mobile device, smartphone, laptop, tablet, PC, wearable computer, appliance, and any other device capable of running an application.

10. The method of claim 7, wherein the performance criteria is at least one selected from the group consisting of application crash reports, activity not responding reports, performance testing reports, battery reports, running services reports, user initiated feedback reports, network reports, and any other criteria indicating the performance of an application.

11. The method of claim 6, wherein the at least one performance issue is selected from the group consisting of a run time error, an application failure, an activity not responding error, a user-initiated negative feedback, a poor battery usage report, a processing delay, a processing error, a trapped error, a network error, and any other issue relating to the performance of the first version of the application.

12. The method of claim 7, wherein the at least one performance issue indicates that the application failed to meet the performance criteria for the application.

13. The method of claim 7, wherein a demographic is at least one selected from the group consisting of a device, a device manufacturer, OS version, locale, carrier, cellular standard, geographic region, and any other demographic having the at least one performance issue.

14. The method of claim 7, wherein the second version of the application is selected from the group consisting of a last known working version of the application, a new version of the application, a beta version of the application, a test version of the application, an unstable version of the application, or a previous version of the application.

15. A system, comprising:
a processor configured to:
receive performance criteria for an application;
determine at least one performance issue relating to a first version of the application, and
automatically provide a second version of the application, wherein the second version is a last known working version of the application.

16. The system of claim 15, wherein the performance criteria are received from one or more devices, and the processor is further configured to identify the second version of the application based on the performance criteria received from the one or more devices.

17. The system of claim 16, wherein the one or more devices includes at least one selected from the group consisting of a mobile device, smartphone, laptop, tablet, PC, wearable computer, appliance, and any other device capable of running an application.

18. The system of claim 15, wherein the performance criteria is at least one selected from the group consisting of application crash reports, activity not responding reports, performance testing reports, battery reports, running services reports, user initiated feedback reports, network reports, and any other criteria indicating the performance of an application.

19. The system of claim 15, wherein the at least one performance issue is selected from the group consisting of a run time error, an application failure, an activity not responding error, a user-initiated negative feedback, a poor battery usage report, a processing delay, a processing error, a trapped error, a network error, and any other issue relating to the performance of the first version of the application.

20. The system of claim 15, wherein the at least one performance issue indicates that the application failed to meet the performance criteria for the application.

21. A system, comprising:
a processor configured to:
receive performance criteria for an application;
determine at least one performance issue relating to a first version of the application, wherein the at least one performance issue is specific to a demographic, and
automatically provide a second version of the application, wherein the second version corrects the at least one performance issue for the demographic.

22. The system of claim 21, wherein the performance criteria are received from one or more devices, and the processor is further configured to identify the second version of the application based on the performance criteria received from the one or more devices.

23. The system of claim 22, wherein the one or more devices includes at least one selected from the group consisting of a mobile device, smartphone, laptop, tablet, PC, wearable computer, appliance, and any other device capable of running an application.

24. The system of claim 21, wherein the performance criteria is at least one selected from the group consisting of application crash reports, activity not responding reports, performance testing reports, battery reports, running services reports, user initiated feedback reports, network reports, and any other criteria indicating the performance of an application.

25. The system of claim 21, wherein the at least one performance issue is selected from the group consisting of a run time error, an application failure, an activity not responding error, a user-initiated negative feedback, a poor battery usage report, a processing delay, a processing error, a trapped error, a network error, and any other issue relating to the performance of the first version of the application.

26. The system of claim 21, wherein the at least one performance issue indicates that the application failed to meet the performance criteria for the application.

27. The system of claim 21, wherein a demographic is at least one selected from the group consisting of a device, a device manufacturer, OS version, locale, carrier, cellular standard, geographic region, and any other demographic having the at least one performance issue.

28. The system of claim 21, wherein the second version of the application is selected from the group consisting of a last known working version of the application, a new version of the application, a beta version of the application, a test version of the application, an unstable version of the application, or a previous version of the application.

29. A computer readable medium storing a plurality of instructions that cause a processor to:
receive performance criteria for an application;
determine at least one performance issue relating to a first version of the application, and
automatically provide a second version of the application, wherein the second version is a last known working version of the application.

30. The computer readable medium of claim 29, wherein the performance criteria are received from one or more devices, and the processor is further configured to identify the second version of the application based on the performance criteria received from the one or more devices.

31. The computer readable medium of claim 29, wherein the performance criteria is at least one selected from the group consisting of application crash reports, activity not responding reports, performance testing reports, battery reports, running services reports, user initiated feedback reports, network reports, and any other criteria indicating the performance of an application.

32. A computer readable medium storing a plurality of instructions that cause a processor to:
receive performance criteria for an application;
determine at least one performance issue relating to a first version of the application, wherein the at least one performance issue is specific to a demographic, and
automatically provide a second version of the application, wherein the second version corrects the at least one performance issue for the demographic.

33. The computer readable medium of claim 32, wherein the performance criteria are received from one or more devices, and the processor is further configured to identify the second version of the application based on the performance criteria received from the one or more devices.

34. The computer readable medium of claim 32, wherein the performance criteria is at least one selected from the group consisting of application crash reports, activity not responding reports, performance testing reports, battery reports, running services reports, user initiated feedback reports, network reports, and any other criteria indicating the performance of an application.

35. The computer readable medium of claim 32, wherein the at least one performance issue is selected from the group consisting of a run time error, an application failure, an activity not responding error, a user-initiated negative feedback, a poor battery usage report, a processing delay, a processing error, a trapped error, a network error, and any other issue relating to the performance of the first version of the application.
